(19) United States
(12) Patent Application Publication
(10) Pub. No.: US 2024/0097172 A1
(43) Pub. Date: Mar. 21, 2024

(54) INLINE SENSORS FOR ELECTROLYTE PRECIPITATION DETECTION IN REDOX FLOW BATTERY SYSTEM

(71) Applicant: UOP LLC, Des Plaines, IL (US)

(72) Inventors: Di Zhao, Kenosha, WI (US); Michael J. McCall, Geneva, IL (US); Stuart R. Miller, Arlington Heights, IL (US)

(21) Appl. No.: 17/932,458

(22) Filed: Sep. 15, 2022

(51) Int. Cl. H01M 8/18; H01M 8/04186; H01M 8/04276

(52) U.S. Cl. CPC H01M 8/188; H01M 8/04194; H01M 8/04276

(57) ABSTRACT

A redox flow battery (RFB) system with a low-cost online turbidity sensor to detect the early stages of electrolyte precipitate formation is described. The inline turbidity sensor can be used in either absorption or scattering mode. The RFB system may optionally include an RGB color sensor to monitor the charge-discharge cycles by detecting color change in the electrolyte.

### BACKGROUND

Energy storage systems play a key role in harvesting and storing energy from a variety of sources for use in a multitude of applications and industries, including building, transportation, utility, and industry. A variety of energy storage systems have been used commercially with new systems currently being developed to meet future storage demands. The development of cost-effective and eco-friendly energy storage systems is essential to solve the energy crisis and to overcome the mismatch between generation and end use. Energy storage solutions currently being explored include electrochemical and battery, thermal, thermochemical, flywheel, compressed air, pumped hydropower, magnetic, biological, chemical and hydrogen energy storage.

Renewable energy sources, such as wind and solar power, have transient characteristics because they rely on environmental conditions and would benefit from associated energy storage to provide power when the wind is not blowing, and the sun is not shining. Battery Energy Storage Systems (BESSs) such as redox flow batteries (RFBs) have attracted significant attention for large-scale stationary applications such as grid scale energy storage. Some of the earliest published work detailing the storage of electrical energy using a redox flow cell dates back to the 1950s when German Chemist Dr. Carl Walther Nicolai Kangro studied the process of storing electrical energy in liquids, using Fe³⁺/Fe²⁺, Cr⁶⁺/Cr³⁺, Ti⁴⁺/Ti³⁺, and Cl⁻/Cl₂ redox couples. In the 1970s, NASA continued to work in this area; produced the first iron chromium redox flow battery in 1973 to store energy at a future moon base. Although interest in establishing a base on the moon faded, flow battery research continued into other chemistries, including zinc-bromine and all-iron flow batteries. In 1981, Hruska et al. demonstrated the ability to cycle an all-iron redox flow battery (IFB) which is an attractive battery energy storage device for large scale energy storage applications, such as load leveling and solar storage, owing to the use of low cost and abundantly available iron, salt, and water as the electrolyte and the chemically safe nature of the system. (Investigation of Factors Affecting Performance of the Iron-Redox Battery, J. Electrochem. Soc., Vol. 28, No. 1, p. 18-25, January, 1981). Later in the 1980s, Skyllas-Kazacos et al from the University of New South Wales, Australia built a prototype vanadium redox flow-battery, leveraging the redox solution chemistry of V²⁺/V³⁺ and V⁴⁺/V⁵⁺. Over the last 40 years, considerable efforts have been made into developing all aspects of flow batteries.

Among various energy storage technologies that having been considered and explored, redox flow batteries (RFB) are unique because they can convert electrical energy into chemical potential energy by means of a reversible electrochemical reaction between two aqueous electrolyte solutions. In their simplest form, RFBs are electrochemical energy storage systems that reversibly convert chemical energy directly to electricity, They are typically composed of two external storage tanks filled with active materials comprising ions that may be in different valance states, two circulation pumps, and a flow cell with a porous separator which is located between the anode and the cathode and is used to separate the anolyte and the catholyte, as well as to utilize the current circuit by allowing the transfer of balancing ions. The anolyte, catholyte, anode, and cathode are commonly referred to as the negative electrolyte, positive electrolyte, negative electrode, and positive electrode, respectively. Therefore, the power and energy capacity can be independent, indicating that the storage capacity is determined by the quantity of electrolyte used and the rating power is decided by the active area as well as the number of the battery stacks.

The all-vanadium redox flow batteries (VRFB) have been the most extensively studied systems because they use the same active species in both half cells, which prevents contamination of electrolytes from one half cell to the other half cell through crossover at the membrane. However, VRFBs; are inherently expensive due to the use of high-cost vanadium.

Similar to VRFBs, all-iron redox flow batteries leverage the same active species (Fe) in different valance states in both the positive and negative electrolytes for the positive and negative electrodes, respectively. The iron-based electrolyte solutions are stored in external storage tanks and flow through the stacks of the batteries. The positive electrode side half-cell reaction involves Fe²⁺ losing electrons to form Fe³⁺ during charge and Fe³⁺ gaining electrons to form Fe²⁺ during discharge; the reaction is given by Equation 1. The negative electrode side half-cell reaction involves the deposition and dissolution of iron in the form of a solid plate; the reaction is given by Equation 2. The overall reaction is shown in Equation 3.

Redox electrode: 2Fe2+↔Fe3++2e−+0.77V (1)

Plating electrode: Fe2++2e−↔Fe0−0.44V (2)

Total: 3Fe2+↔Fe0+2Fe3+1.21V (3)

During the normal operation of an RFB, small inefficiencies can create large problems over the lifetime of the battery. These problems can stem from several sources such as: cross-over of active species across the membrane, parasitic side reactions, or incomplete discharging of the battery. Even small inefficiencies can eventually result in a poorly performing battery in a product designed to last more than 20,000 cycles. Engineering designs are often required to inhibit or correct these inefficiencies. Current processes and systems employed for rebalancing the all-iron RFB cells are concerned with the reduction of Fe3+ to Fe2+ to control the state of charge of the positive electrolyte. Different engineering approaches (electrochemical or catalytic) have demonstrated electrolyte rebalance within all-iron redox flow batteries; however, the basic principle of ferric ion reduction remains largely unchanged from that taught by Thaller and Noah, where H2(g) is oxidized to yield protons (2H+) and electrons (2e−) which enables the catalytic reduction of Fe3+ in the positive electrolyte to Fe2+. The reduction of Fe3+ to Fe2+ enables modification of the state of charge of the positive electrolyte; however, the protons (H+) migrate into the positive electrolyte. This process results in the removal of protons (H+) from the negative electrolyte (during hydrogen evolution) and release into the positive electrolyte (during rebalancing). A consequence of proton removal from the negative electrolyte (H2 evolution) and insertion into the positive electrolyte (H2 recombination) is the divergence of electrolyte pH from optimal operating values (the positive electrolyte becomes more acidic and the negative electrolyte becomes less acidic). Increasing the pH of the negative electrolyte can lead to the inability to completely oxidize plated iron to ferrous cations or the oxidation or loss of Fe0 from the cell either as an iron oxyhydroxide, iron oxide, or as iron flakes. This results in reduced capacity in the negative electrolyte and lead to precipitates/sediments being circulated in the electrolyte loop, which can lead to the formation of blockages over time. The direct introduction of Fe3+ cations to the higher pH negative electrolyte can lead to the precipitation of iron oxyhydroxide or iron oxide byproducts which can lead to obstruction of electrolyte flow and battery failure.

One of the biggest challenges for long-term operation of RFBs is the precipitation of the electrolyte. For example, in an iron flow battery (IFB), hydrogen evolution reactions increase the pH of the negative electrolyte, causing precipitation of iron hydroxides. The formed precipitates may attach on the separator membrane and electrodes, reduce membrane conductivity and interfere with adsorption of iron ions at the electrode surface. Almost all RFB systems including, but not limited to, V, Fe, and Zn, suffer from this problem.

Ideally, IFBs are operated with the negative electrolyte solution in a very narrow pH window, such that it is as high as possible to limit the possibility to generate H2 at the negative electrode and as low as possible to inhibit the unwanted formation of iron oxides and hydroxides. However, the pH profile throughout large IFB installations is not uniform, and it is conceivable that the pH immediately after leaving the stack may be higher than the bulk electrolyte, resulting in localized areas in the system prone to the formation of precipitates.

Precipitates that form and stay within battery stacks are typically dissolved back into the electrolyte through consecutive charge and discharge cycles. However, any that break free from the stacks or system manifolding can settle in the electrolyte storage tanks and become difficult to redissolve back into solution, be pumped back through the electrolyte loop potentially resulting in damage to process equipment and instruments, or cause blockages in the electrolyte piping or battery stacks. Additionally, formation of iron-based precipitates will decrease the concentration of active redox species in the RFB, decreasing the overall capacity of the electrolyte. This impact can worsen over time if precipitates settle to the bottom of tanks and are not redissolved in solution. In this way, precipitates and any other undesirable particulates suspended in the electrolytes can be detrimental to system mechanical reliability, electrochemical performance, and subsequent system efficiency.

Therefore, there is a need for a simple and effective method to identify the formation of precipitates during operation of the RFB.

### BRIEF DESCRIPTION OF THE DRAWINGS

FIG. 1 illustrates one embodiment of a RFB system with a turbidity sensor.

FIG. 2 illustrates another embodiment of a RFB system with a rebalancing cell and a turbidity sensor.

FIG. 3 illustrates another embodiment of a RFB system with a rebalancing cell, a diffusion cell, and a turbidity sensor.

FIG. 4 is a graph showing turbidity and pH as a function of time.

### DESCRIPTION

A low-cost online turbidity sensor can detect the formation of electrolyte precipitates in early stages. The inline turbidity sensor can be used in either absorption or scattering mode to capture the pH change of the negative electrolyte and detect the formation of precipitates. As the pH increases, the sensor signals start to drift downward due to the formation and accumulation of precipitates. For example, in hybrid redox flow batteries, such as IFBs, it is desirable to monitor the formation of electrolyte precipitates in early stages. This may allow operators to take actions to prevent battery performance degradation. By monitoring the formation of precipitates in real-time, the turbidity sensor may also allow the operator to run the RFB in higher efficiency (DoD) without reducing the lifetime of the battery.

In addition, the turbidity sensor may also be used to detect the amount of gas bubbles generated in the hydrogen evolution reaction (HER). It can be used together with the pressure sensor to monitor the condition of HER in an RFB system.

Another potential benefit of the online turbidity sensor is the ability to monitor the charge-discharge cycles by detecting the slight color change of the electrolyte during the charge-discharge cycles. For example, in some RFBs, such as an IFB, the color of the electrolyte changes in the charge-discharge process. With more precipitates formed, fewer Fe²⁺ ions can be reduced, and the sensor's response to the color change is slowly degraded. The color change correlates to the state-of-charge (SoC) of the electrolyte. An inline RGB color sensor which measures the color of the electrolyte could be used to determine the SoC of the electrolyte. Alternatively, a combination of an LED or other light source with a light wavelength in the 400-900 nm range and photodiodes could be used to determine the color change of the electrolyte. In this case, the change in the color of the electrolyte leads to a shift in the peak wavelength of the light absorbed by the electrolyte. By using a emitting light wavelength with a peak close to the peak wavelength of the light absorbed by the electrolyte, the color change can be detected by measuring the intensity of the light that passes through the electrolyte using the photodiodes.

By using the turbidity sensor together with other online sensors, such as RGB (red/green/blue) sensors, a model can be developed to monitor the redox flow battery health conditions and identify the potential failure modes, such as precipitation due to pH change, detaching of plated metal from the electrode etc.

The turbidity sensor can also be used to detect other failure modes, such as plated Fe particles detaching from the electrode and the decomposing of the membrane or other battery components.

The data from the turbidity sensor and other sensors can be used to develop a process model. The process model and sensor data obtained during operation can then be used to monitor and predict the condition of the RFB. This may allow the operator to optimize RFB performance and maximize cycle length.

An inline sensor which has a built-in flow cell can be hooked up in the flow loop directly. A turbidity probe without a flow cell can be installed in a T-connector and then connected to the flow loop. The sensor can be installed either in the main stream or in a bypass stream.

The careful placement of turbidity sensors and/or color sensors in RFB systems, especially hybrid systems, helps to maintaining overall system health. Turbidity sensors can be located before or after individual stacks or strings of stacks, as well as before or after electrolyte storage tanks to detect the formation and accumulation of precipitates in the electrolyte and minimize the occurrence of blockages within stacks or the introduction of solids to electrolyte tanks. Filters may also be positioned before or after system rebalancing components (if present), such as systems to enable hydrogen recombination, or systems to enable electrolyte tank rebalancing (if present). In a system such as an iron flow battery, iron precipitates, such as Fe⁰ or Fe₂O₃, Fe(OH)₃, Fe(OH)₂ etc., are less stable at lower pH values and may redissolve back into the electrolyte during battery cycling. Alternatively, the formation of precipitates in the IFB system may require corrective action to be taken to ensure the system continues to operate at optimal efficiency.

Various types of RFB can be used. Suitable RFB include, but are not limited to, Fe/Sn, Fe/Ti, Fe/Cr, Fe/Fe, Fe/Zn, V/V, Zn/Br, and Zn/Ce.

The redox active species for the RFB depend on the type of RFB. The redox active species for a Fe/Sn RFB comprise Fe²⁺/Fe³⁺ and Sn⁰/Sn²⁺. The redox active species for a Fe/Ti RFB comprise Fe²⁺/Fe³⁺ and Ti³⁺/Ti⁴⁺. The redox active species for a Fe/Cr RFB comprise Fe²⁺/Fe³⁺ and Cr²⁺/Cr³⁺. The redox active species for a Fe/Fe RFB comprise Fe²⁺/Fe³⁺ and Fe²⁺/Fe °. The redox active species for a Fe/Zn RFB comprise Fe²⁺/Fe³⁺ and Zn⁰/Zn²⁺. The redox active species for a V/V RFB comprise VO₂⁺/VO²⁺ and V²⁺/V³⁺. The redox active species for a Zn/Br RFB comprise Br₂/Br⁻ and Zn⁰/Zn²⁺. The redox active species for a Zn/Ce RFB comprise Ce³⁺/Ce⁴⁺ and Zn²⁺/Zn⁰.

One aspect of the invention is a redox flow battery system. In one embodiment, the redox flow battery system comprises at least one rechargeable cell comprising a positive electrode, a negative electrode, and a separator positioned between the positive electrode and the negative electrode, a positive electrolyte tank comprising a positive electrolyte in fluid communication with the positive electrode, the positive electrolyte flowing from the positive fluid tank to the positive electrode and from the positive electrode to the positive electrolyte tank in a positive electrolyte flow loop, and a negative electrolyte tank comprising a negative electrolyte in fluid communication with the negative electrode, the negative electrolyte flowing from the negative fluid tank to the negative electrode and from the negative electrode to the negative electrolyte tank in a negative electrolyte flow loop; and a turbidity sensor in the negative electrolyte flow loop to monitor precipitates or hydrogen bubbles or both in the negative electrolyte, or a turbidity sensor in the positive electrolyte flow loop to monitor precipitates in the positive electrolyte, or both.

In some embodiments, the turbidity sensor in the negative electrolyte flow loop is positioned between the negative electrolyte tank and the negative electrode, or between the negative electrode and the negative electrolyte tank, or both; or wherein the turbidity sensor in the positive electrolyte flow loop is positioned between the positive electrolyte tank and the positive electrode, or between the positive electrode and the positive electrolyte tank; or both.

In some embodiments, the turbidity sensor is located in the negative flow loop or in a slipstream from the negative flow loop; or wherein the turbidity sensor is located in the positive flow loop or in a slipstream from the positive flow loop; or both.

In some embodiments, the turbidity sensor comprises a flow cell, an absorption turbidity sensor or a light scattering turbidity sensor.

In some embodiments, the turbidity sensor is positioned directly in the negative electrolyte flow loop or the positive electrolyte flow loop or both.

In some embodiments, the turbidity sensor is positioned in a connector in fluid communication with the negative electrolyte flow loop or the positive flow loop or both.

In some embodiments, the redox flow battery system further comprises: a color sensor in the positive electrolyte flow loop to determine a state of charge of the positive electrolyte, or a color sensor in the negative electrolyte flow loop to determine a state of charge of the negative electrolyte, or both, wherein the color sensor comprises a red/green/blue (RGB) sensor or a light source and a photodiode.

In some embodiments, the redox flow battery system further comprises: a rebalancing cell, a diffusion cell, or both.

In some embodiments, the redox flow battery system further comprises: a color sensor in the positive electrolyte flow loop between the positive electrode and the positive electrolyte tank to determine a state of charge of the positive electrolyte, or a color sensor in the negative electrolyte flow loop between the negative electrode and the negative electrolyte tank to determine a state of charge of the negative electrolyte, or both, wherein the color sensor comprises a red/green/blue (RGB) sensor or a light source and a photodiode.

In some embodiments, the redox flow battery comprises a hybrid flow battery system.

In some embodiments, the redox flow battery system comprises an iron flow battery system.

Another aspect of the invention is a redox flow battery system. In one embodiment, the redox flow battery system comprises: at least one rechargeable cell comprising a positive electrode, a negative electrode, and a separator positioned between the positive electrode and the negative electrode, a positive electrolyte tank comprising a positive electrolyte in fluid communication with the positive electrode, the positive electrolyte flowing from the positive fluid tank to the positive electrode and from the positive electrode to the positive electrolyte tank in a positive electrolyte flow loop, and a negative electrolyte tank comprising a negative electrolyte in fluid communication with the negative electrode, the negative electrolyte flowing from the negative fluid tank to the negative electrode and from the negative electrode to the negative electrolyte tank in a negative electrolyte flow loop; a turbidity sensor in the negative electrolyte flow loop to monitor precipitates or hydrogen bubbles or both in the negative electrolyte, or a turbidity sensor in the positive electrolyte flow loop to monitor precipitates in the positive electrolyte, or both; wherein the turbidity sensor comprises a flow cell, an absorption turbidity sensor, or a light scattering turbidity sensor; wherein the turbidity sensor is positioned between the negative electrolyte tank and the negative electrode, or between the negative electrode and the negative electrolyte tank, or both; or wherein the turbidity sensor positioned between the positive electrolyte tank and the positive electrode, or between the positive electrode and the positive electrolyte tank, or both; or both.

In some embodiments, the turbidity sensor is located in the negative flow loop or in a slipstream from the negative flow loop; or wherein the turbidity sensor is located in the positive flow loop or in a slipstream from the positive flow loop; or both. In some embodiments, the turbidity sensor is positioned directly in the negative electrolyte flow loop or the positive electrolyte flow loop or both.

In some embodiments, the turbidity sensor is positioned in a connector in fluid communication with the negative electrolyte flow loop or the positive flow loop or both.

In some embodiments, the redox flow battery system further comprises: a color sensor in the positive electrolyte flow loop to determine a state of charge of the positive electrolyte, or a color sensor in the negative electrolyte flow loop to determine a state of charge of the negative electrolyte, or both, wherein the color sensor comprises a red/green/blue (RGB) sensor or a light source and a photodiode.

In some embodiments, the redox flow battery system further comprises: a rebalancing cell in fluid communication with the negative electrolyte tank, or the positive electrolyte tank, or both and in fluid communication with the positive electrode and the positive electrolyte tank.

In some embodiments, the redox flow battery system further comprises: a color sensor in the positive electrolyte flow loop between the positive electrode and the positive electrolyte tank to determine a state of charge of the positive electrolyte, or a color sensor in the negative electrolyte flow loop between the negative electrode and the negative electrolyte tank to determine a state of charge of the negative electrolyte, or both, wherein the color sensor comprises a red/green/blue (RGB) sensor or a light source and a photodiode.

In some embodiments, the redox flow battery comprises a hybrid flow battery system.

In some embodiments, the redox flow battery system comprises an iron flow battery system.

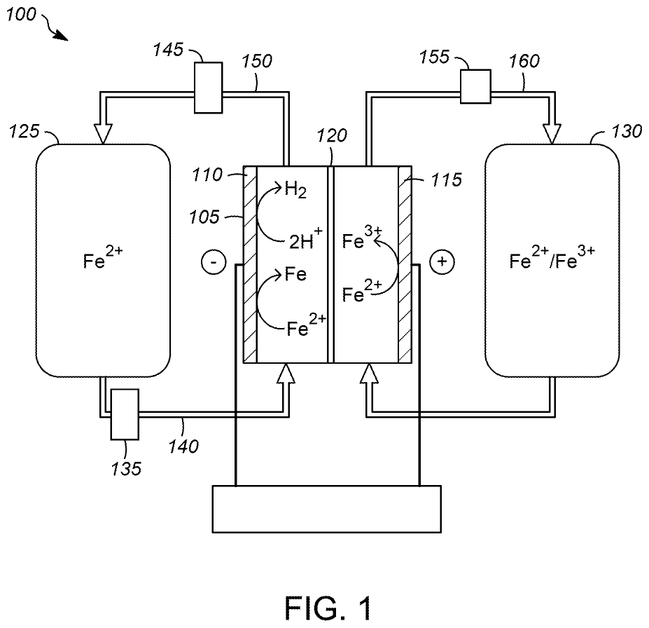

FIG. 1 illustrates one embodiment of an RFB system 100. It should be noted that although the RFB system is being described as an IFB, the RFB system is not limited to an IFB system. Other RFB systems could also be used.

The RFB system 100 includes a rechargeable cell 105 comprising a negative electrode 110, a positive electrode 115, and a separator 120. There is a negative electrolyte tank 125 and a positive electrolyte tank 130.

The negative electrolyte is circulated in a negative electrolyte loop from the negative electrolyte tank 125 to the negative electrode 110 in the rechargeable cell 105 and back to the negative electrolyte tank 125. There is an inline turbidity sensor 135 on the line 140 from the negative electrolyte tank 125 to negative electrode 110 in the rechargeable cell 105 and another inline turbidity sensor 145 on the line 150 from the negative electrode 110 in the rechargeable cell 105 to the negative electrolyte tank 125. The positive electrolyte is circulated in a positive electrolyte loop from the positive electrolyte tank 130 to the positive electrode 115 in the rechargeable cell 105 and back to the positive electrolyte tank 130. There is an RGB sensor 155 on the line 160 from the positive electrode 115 in the rechargeable cell 105 to the positive electrolyte tank 130.

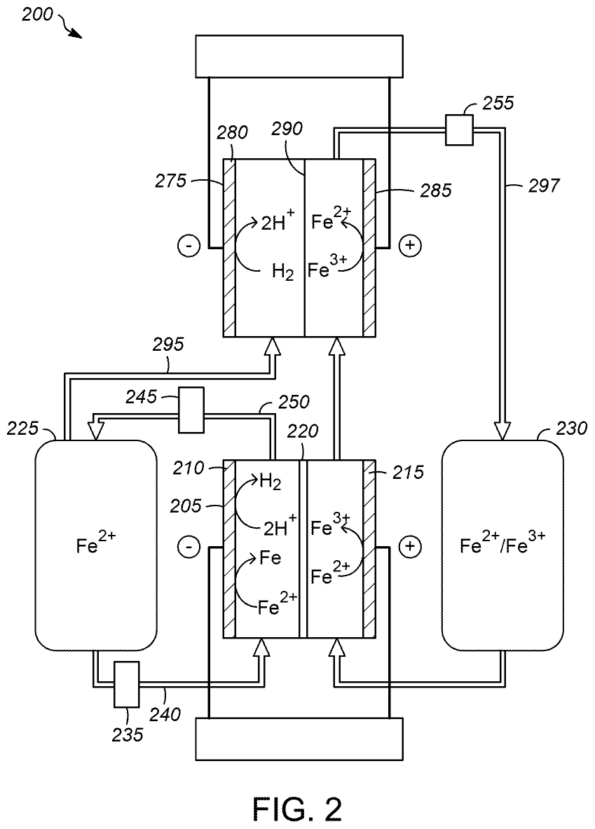

FIG. 2 illustrates another embodiment of an RFB system 200 with a rebalancing cell 275. The RFB system 200 includes a rechargeable cell 205 comprising a negative electrode 210, a positive electrode 215, and a separator 220. There is a negative electrolyte tank 225 and a positive electrolyte tank 230. The RFB system includes a rebalancing cell 275 comprising a negative electrode 280, a positive electrode 285 and a separator 290.

The negative electrolyte is circulated in a negative electrolyte loop from the negative electrolyte tank 225 to the negative electrode 210 in the rechargeable cell 205 and back to the negative electrolyte tank 225. There is an inline turbidity sensor 235 on the line 240 from the negative electrolyte tank 225 to negative electrode 210 in the rechargeable cell 205 and another inline turbidity sensor 245 on the line 250 from the negative electrode 210 in the rechargeable cell 205 to the negative electrolyte tank 225.

The positive electrolyte is circulated from the positive electrolyte tank 230 to the positive electrode 215 in the rechargeable cell 205. The positive electrolyte flows from the positive electrode 215 in the rechargeable cell 205 to the positive electrode 285 of the rebalancing cell 275. Hydrogen gas from the negative electrolyte tank 225 flows through line 295 to the negative electrode 280 of the rebalancing cell 275 where Fe⁺³ is converted to Fe⁺² by the H⁺ ions. Positive electrolyte with an increased level of Fe⁺² flows from the positive electrode 285 of the rebalancing cell 275 to the positive electrolyte tank 230. There is an RGB sensor 255 on line 297 from the rebalancing cell 275 to the positive electrolyte tank 230.

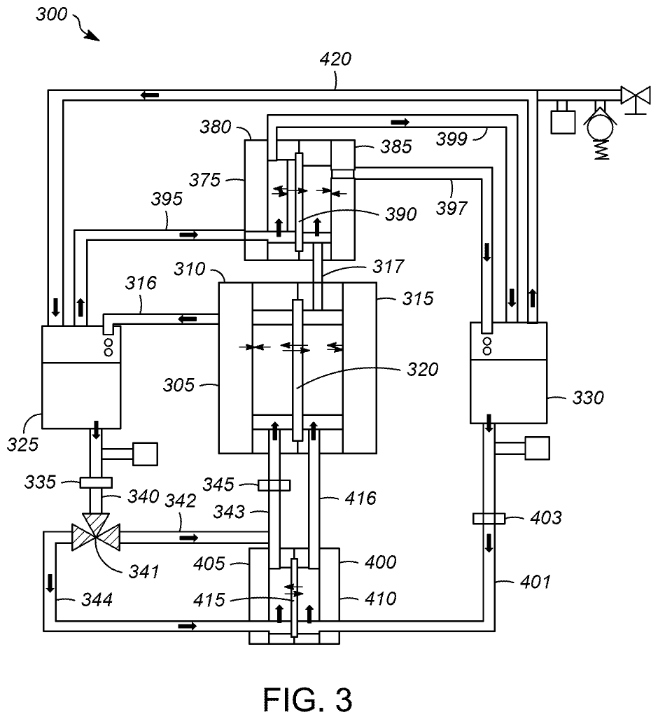

FIG. 3 illustrates another embodiment of an RFB system 200 with a rebalancing cell 275 and a diffusion cell 400. The RFB system 300 includes a rechargeable cell 305 comprising a negative electrode 310, a positive electrode 315, and a separator 320. There is a negative electrolyte tank 325 and a positive electrolyte tank 330. The rebalancing cell 375 comprisies a negative electrode 380, a positive electrode 385 and a separator 390. The diffusion cell 400 comprises a negative electrode 405, a positive electrode 410, and a separator 415.

The negative electrolyte may be circulated from the negative electrolyte tank 325 directly to the negative electrode 310 in the rechargeable cell 305 through lines 342 and 343. Alternatively, it may flow from the negative electrolyte tank 325 to the negative electrode 405 of the diffusion cell 400 through line 344 and then to the negative electrode 310 in the rechargeable cell 305 through line 343. The flow path is controlled by valve 341. The negative electrolyte flows from the negative electrode 310 of the rechargeable cell 305 back to the negative electrolyte tank 325 through line 316. There is an inline turbidity sensor 335 on the line 340 from the negative electrolyte tank 325 to the valve 341 and another inline turbidity sensor 345 on line 343.

The positive electrolyte is circulated from the positive electrolyte tank 330 to the positive electrode 410 in the diffusion cell 400 through line 401. There is an RGB sensor 403 on line 401 from the positive electrolyte tank 330 to the diffusion cell 400.

The positive electrolyte flows from the positive electrode 410 in the diffusion cell 400 to the positive electrode 315 of the rechargeable cell 305 through line 416. The positive electrolyte then flows from the positive electrode 315 of the rechargeable cell 305 to the positive electrode 385 of the rebalancing cell 375 through line 317. Hydrogen gas from the negative electrolyte tank 325 flows through line 395 to the negative electrode 380 of the rebalancing cell 375. Part of the hydrogen gas is oxidized to H⁺ ions pass through the separator 390 and convert Fe⁺² to Fe⁺². Positive electrolyte with an increased level of Fe⁺² flows from the positive electrode 385 of the rebalancing cell 375 to the positive electrolyte tank 330 through line 397.

Unreacted hydrogen gas flows from the negative electrode 380 of the rebalancing cell 375 to the positive electrolyte tank 330 through line 399.

Hydrogen gas flows between the positive electrolyte tank 330 and the negative electrolyte tank 325 through line 420 to balance the headspace pressure in the tanks.

The diffusion cell 400 is used to help balance the pH of the electrolyte. No voltage is applied to the diffusion cell 400, and no redox reactions occur in it. Valve 341 controls when the diffusion cell is connected to the negative electrolyte flow path. In normal operation, the negative electrolyte flows from the negative electrolyte tank 325 to the negative electrode 310 of the rechargeable cell 305 directly through lines 340, 342, and 343. When the output of the turbidity sensor 335 falls below a first predetermined limit indicating that the pH is above a desired operating level, valve 341 diverts the negative electrolyte flow to the diffusion cell 400 through line 344. The diffusion cell 400 allows protons to diffuse from the positive electrolyte to the negative electrolyte across the separator 415 to reduce the pH of the negative electrolyte. When the output of the turbidity sensor 335 reaches a second predetermined limit indicating that the pH of the negative electrolyte is below a desired operating level, valve 341 disconnects the diffusion cell 400, and the negative electrolyte flows through lines 342 and 343 to the rechargeable cell 305.

### Examples

A turbidity sensor was installed between the negative tank and the negative electrode and tested with the IFB system which contains a H₂ rebalancing cell. The schematic diagram of the test setup is shown in FIG. 2. The turbidity sensor showed repeating up-and-down patterns corresponding to the color change of negative electrolyte during charge-discharge cycles. During the battery charge process, with Fe²⁺ being reduced to Fe⁰ and plated on the negative electrode, the color of negative electrolyte became very light green and the output of the turbidity sensor increased. During discharge, Fe was converted back to Fe²⁺, and the turbidity sensor's output decreased with the color of negative electrolyte becoming darker.

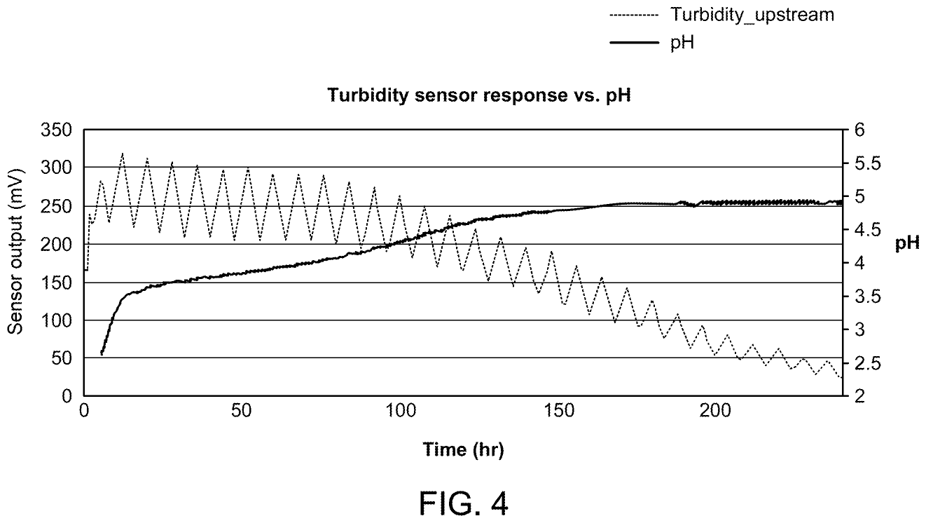

The response of turbidity sensor showed good correlation with the pH change of the negative electrolyte as shown in FIG. 4. With pH increasing to above 4.3, the sensor signals started to drift down due to the formation and accumulation of precipitates. The sensor's response to the battery charge-discharge cycles also gradually degraded with the concentration of Fe²⁺ ions in negative electrolyte continuously decreasing.

### Specific Embodiments

While the following is described in conjunction with specific embodiments, it will be understood that this description is intended to illustrate and not limit the scope of the preceding description and the appended claims.

A first embodiment of the invention is a redox flow battery system comprising at least one rechargeable cell comprising a positive electrode, a negative electrode, and a separator positioned between the positive electrode and the negative electrode, a positive electrolyte tank comprising a positive electrolyte in fluid communication with the positive electrode, the positive electrolyte flowing from the positive fluid tank to the positive electrode and from the positive electrode to the positive electrolyte tank in a positive electrolyte flow loop, and a negative electrolyte tank comprising a negative electrolyte in fluid communication with the negative electrode, the negative electrolyte flowing from the negative fluid tank to the negative electrode and from the negative electrode to the negative electrolyte tank in a negative electrolyte flow loop; and a turbidity sensor in the negative electrolyte flow loop to monitor precipitates or hydrogen bubbles or both in the negative electrolyte, or a turbidity sensor in the positive electrolyte flow loop to monitor precipitates in the positive electrolyte, or both. An embodiment of the invention is one, any or all of prior embodiments in this paragraph up through the first embodiment in this paragraph wherein the turbidity sensor in the negative electrolyte flow loop is positioned between the negative electrolyte tank and the negative electrode, or between the negative electrode and the negative electrolyte tank, or both; or wherein the turbidity sensor in the positive electrolyte flow loop is positioned between the positive electrolyte tank and the positive electrode, or between the positive electrode and the positive electrolyte tank; or both. An embodiment of the invention is one, any or all of prior embodiments in this paragraph up through the first embodiment in this paragraph wherein the turbidity sensor is located in the negative flow loop or in a slipstream from the negative flow loop; or wherein the turbidity sensor is located in the positive flow loop or in a slipstream from the positive flow loop; or both. An embodiment of the invention is one, any or all of prior embodiments in this paragraph up through the first embodiment in this paragraph wherein the turbidity sensor comprises a flow cell, an absorption turbidity sensor or a light scattering turbidity sensor. An embodiment of the invention is one, any or all of prior embodiments in this paragraph up through the first embodiment in this paragraph wherein the turbidity sensor is positioned directly in the negative electrolyte flow loop or the positive electrolyte flow loop or both. An embodiment of the invention is one, any or all of prior embodiments in this paragraph up through the first embodiment in this paragraph wherein the turbidity sensor is positioned in a connector in fluid communication with the negative electrolyte flow loop or the positive flow loop or both. An embodiment of the invention is one, any or all of prior embodiments in this paragraph up through the first embodiment in this paragraph further comprising a color sensor in the positive electrolyte flow loop to determine a state of charge of the positive electrolyte, or a color sensor in the negative electrolyte flow loop to determine a state of charge of the negative electrolyte, or both, wherein the color sensor comprises a red/green/blue (RGB) sensor or a light source and a photodiode. An embodiment of the invention is one, any or all of prior embodiments in this paragraph up through the first embodiment in this paragraph further comprising a rebalancing cell, a diffusion cell, or both. An embodiment of the invention is one, any or all of prior embodiments in this paragraph up through the first embodiment in this paragraph further comprising a color sensor in the positive electrolyte flow loop between the positive electrode and the positive electrolyte tank to determine a state of charge of the positive electrolyte, or a color sensor in the negative electrolyte flow loop between the negative electrode and the negative electrolyte tank to determine a state of charge of the negative electrolyte, or both, wherein the color sensor comprises a red/green/blue (RGB) sensor or a light source and a photodiode. An embodiment of the invention is one, any or all of prior embodiments in this paragraph up through the first embodiment in this paragraph further comprising a diffusion cell comprising a positive electrode, a negative electrode, and a separator positioned between the positive electrode and the negative electrode, the diffusion cell being in fluid communication with an outlet of the positive electrolyte tank and an inlet to a positive electrode side of the rechargeable cell, and the diffusion cell being in selective communication an outlet of the negative electrolyte tank and an inlet of a negative side of the rechargeable cell. An embodiment of the invention is one, any or all of prior embodiments in this paragraph up through the first embodiment in this paragraph wherein the redox flow battery comprises a hybrid flow battery system. An embodiment of the invention is one, any or all of prior embodiments in this paragraph up through the first embodiment in this paragraph wherein the redox flow battery system comprises an iron flow battery system.

A second embodiment of the invention is a redox flow battery system comprising at least one rechargeable cell comprising a positive electrode, a negative electrode, and a separator positioned between the positive electrode and the negative electrode, a positive electrolyte tank comprising a positive electrolyte in fluid communication with the positive electrode, the positive electrolyte flowing from the positive fluid tank to the positive electrode and from the positive electrode to the positive electrolyte tank in a positive electrolyte flow loop, and a negative electrolyte tank comprising a negative electrolyte in fluid communication with the negative electrode, the negative electrolyte flowing from the negative fluid tank to the negative electrode and from the negative electrode to the negative electrolyte tank in a negative electrolyte flow loop; a turbidity sensor in the negative electrolyte flow loop to monitor precipitates or hydrogen bubbles or both in the negative electrolyte, or a turbidity sensor comprising a flow cell in the positive electrolyte flow loop to monitor precipitates in the positive electrolyte, or both; wherein the turbidity sensor comprises a flow cell, an absorption turbidity sensor, or a light scattering turbidity sensor; wherein the turbidity sensor is positioned between the negative electrolyte tank and the negative electrode, or between the negative electrode and the negative electrolyte tank, or both; or wherein the turbidity sensor positioned between the positive electrolyte tank and the positive electrode, or between the positive electrode and the positive electrolyte tank, or both; or both. An embodiment of the invention is one, any or all of prior embodiments in this paragraph up through the second embodiment in this paragraph wherein the turbidity sensor is located in the negative flow loop or in a slipstream from the negative flow loop; or wherein the turbidity sensor is located in the positive flow loop or in a slipstream from the positive flow loop; or both. An embodiment of the invention is one, any or all of prior embodiments in this paragraph up through the second embodiment in this paragraph wherein the turbidity sensor is positioned directly in the negative electrolyte flow loop or the positive electrolyte flow loop or both. An embodiment of the invention is one, any or all of prior embodiments in this paragraph up through the second embodiment in this paragraph wherein the turbidity sensor is positioned in a connector in fluid communication with the negative electrolyte flow loop or the positive flow loop or both. An embodiment of the invention is one, any or all of prior embodiments in this paragraph up through the second embodiment in this paragraph further comprising a color sensor in the positive electrolyte flow loop to determine a state of charge of the positive electrolyte, or a color sensor in the negative electrolyte flow loop to determine a state of charge of the negative electrolyte, or both, wherein the color sensor comprises a red/green/blue (RGB) sensor or a light source and a photodiode. An embodiment of the invention is one, any or all of prior embodiments in this paragraph up through the second embodiment in this paragraph further comprising a rebalancing cell in fluid communication with the negative electrolyte tank, or the positive electrolyte tank, or both and in fluid communication with the positive electrode and the positive electrolyte tank. An embodiment of the invention is one, any or all of prior embodiments in this paragraph up through the second embodiment in this paragraph further comprising a color sensor in the positive electrolyte flow loop between the positive electrode and the positive electrolyte tank to determine a state of charge of the positive electrolyte, or a color sensor in the negative electrolyte flow loop between the negative electrode and the negative electrolyte tank to determine a state of charge of the negative electrolyte, or both, wherein the color sensor comprises a red/green/blue (RGB) sensor or a light source and a photodiode. An embodiment of the invention is one, any or all of prior embodiments in this paragraph up through the second embodiment in this paragraph further comprising a diffusion cell comprising a positive electrode, a negative electrode, and a separator positioned between the positive electrode and the negative electrode, the diffusion cell being in fluid communication with an outlet of the positive electrolyte tank and an inlet to a positive electrode side of the rechargeable cell, and the diffusion cell being in selective communication an outlet of the negative electrolyte tank and an inlet of a negative side of the rechargeable cell. An embodiment of the invention is one, any or all of prior embodiments in this paragraph up through the second embodiment in this paragraph wherein the redox flow battery comprises a hybrid flow battery system. An embodiment of the invention is one, any or all of prior embodiments in this paragraph up through the second embodiment in this paragraph wherein the redox flow battery system comprises an iron flow battery system.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A redox flow battery system comprising:
at least one rechargeable cell comprising a positive electrode, a negative electrode, and a separator positioned between the positive electrode and the negative electrode, a positive electrolyte tank comprising a positive electrolyte in fluid communication with the positive electrode, the positive electrolyte flowing from the positive fluid tank to the positive electrode and from the positive electrode to the positive electrolyte tank in a positive electrolyte flow loop, and a negative electrolyte tank comprising a negative electrolyte in fluid communication with the negative electrode, the negative electrolyte flowing from the negative fluid tank to the negative electrode and from the negative electrode to the negative electrolyte tank in a negative electrolyte flow loop; and
a turbidity sensor in the negative electrolyte flow loop to monitor precipitates or hydrogen bubbles or both in the negative electrolyte, or a turbidity sensor in the positive electrolyte flow loop to monitor precipitates in the positive electrolyte, or both.

2. The redox flow battery system of claim 1 wherein the turbidity sensor in the negative electrolyte flow loop is positioned between the negative electrolyte tank and the negative electrode, or between the negative electrode and the negative electrolyte tank, or both; or wherein the turbidity sensor in the positive electrolyte flow loop is positioned between the positive electrolyte tank and the positive electrode, or between the positive electrode and the positive electrolyte tank; or both.

3. The redox flow battery system of claim 1 wherein the turbidity sensor is located in the negative flow loop or in a slipstream from the negative flow loop; or wherein the turbidity sensor is located in the positive flow loop or in a slipstream from the positive flow loop; or both.

4. The redox flow battery system of claim 1 wherein the turbidity sensor comprises a flow cell, an absorption turbidity sensor or a light scattering turbidity sensor.

5. The redox flow battery system of claim 4 wherein the turbidity sensor is positioned directly in the negative electrolyte flow loop or the positive electrolyte flow loop or both.

6. The redox flow battery system of claim 1 wherein the turbidity sensor is positioned in a connector in fluid communication with the negative electrolyte flow loop or the positive flow loop or both.

7. The redox flow battery system of claim 1 further comprising:
a color sensor in the positive electrolyte flow loop to determine a state of charge of the positive electrolyte, or a color sensor in the negative electrolyte flow loop to determine a state of charge of the negative electrolyte, or both, wherein the color sensor comprises a red/green/blue (RGB) sensor or a light source and a photodiode.

8. The redox flow battery system of claim 1 further comprising:
a rebalancing cell, a diffusion cell, or both.

9. The redox flow battery system of claim 1 further comprising:
a diffusion cell comprising a positive electrode, a negative electrode, and a separator positioned between the positive electrode and the negative electrode, the diffusion cell being in fluid communication with an outlet of the positive electrolyte tank and an inlet to a positive electrode side of the rechargeable cell, and the diffusion cell being in selective communication an outlet of the negative electrolyte tank and an inlet of a negative side of the rechargeable cell.

10. The redox flow battery system of claim 1 further comprising:
a color sensor in the positive electrolyte flow loop between the positive electrode and the positive electrolyte tank to determine a state of charge of the positive electrolyte, or a color sensor in the negative electrolyte flow loop between the negative electrode and the negative electrolyte tank to determine a state of charge of the negative electrolyte, or both, wherein the color sensor comprises a red/green/blue (RGB) sensor or a light source and a photodiode.

11. The redox flow battery system of claim 1 wherein the redox flow battery comprises a hybrid flow battery system.

12. The redox flow battery system of claim 1 wherein the redox flow battery system comprises an iron flow battery system.

13. A redox flow battery system comprising:
at least one rechargeable cell comprising a positive electrode, a negative electrode, and a separator positioned between the positive electrode and the negative electrode, a positive electrolyte tank comprising a positive electrolyte in fluid communication with the positive electrode, the positive electrolyte flowing from the positive fluid tank to the positive electrode and from the positive electrode to the positive electrolyte tank in a positive electrolyte flow loop, and a negative electrolyte tank comprising a negative electrolyte in fluid communication with the negative electrode, the negative electrolyte flowing from the negative fluid tank to the negative electrode and from the negative electrode to the negative electrolyte tank in a negative electrolyte flow loop; and
a turbidity sensor in the negative electrolyte flow loop to monitor precipitates or hydrogen bubbles or both in the negative electrolyte, or a turbidity sensor comprising a flow cell in the positive electrolyte flow loop to monitor precipitates in the positive electrolyte, or both; wherein the turbidity sensor comprises a flow cell, an absorption turbidity sensor, or a light scattering turbidity sensor; wherein the turbidity sensor is positioned between the negative electrolyte tank and the negative electrode, or between the negative electrode and the negative electrolyte tank, or both; or wherein the turbidity sensor positioned between the positive electrolyte tank and the positive electrode, or between the positive electrode and the positive electrolyte tank, or both; or both.

14. The redox flow battery system of claim 13 wherein the turbidity sensor is located in the negative flow loop or in a slipstream from the negative flow loop; or wherein the turbidity sensor is located in the positive flow loop or in a slipstream from the positive flow loop; or both.

15. The redox flow battery system of claim 14 wherein the turbidity sensor is positioned directly in the negative electrolyte flow loop or the positive electrolyte flow loop or both.

16. The redox flow battery system of claim 13 wherein the turbidity sensor is positioned in a connector in fluid communication with the negative electrolyte flow loop or the positive flow loop or both.

17. The redox flow battery system of claim 13 further comprising:
a color sensor in the positive electrolyte flow loop to determine a state of charge of the positive electrolyte, or a color sensor in the negative electrolyte flow loop to determine a state of charge of the negative electrolyte, or both, wherein the color sensor comprises a red/green/blue (RGB) sensor or a light source and a photodiode.

18. The redox flow battery system of claim 13 further comprising:
a rebalancing cell in fluid communication with the negative electrolyte tank, or the positive electrolyte tank, or both and in fluid communication with the positive electrode and the positive electrolyte tank.

19. The redox flow battery system of claim 18 further comprising:
a color sensor in the positive electrolyte flow loop between the positive electrode and the positive electrolyte tank to determine a state of charge of the positive electrolyte, or a color sensor in the negative electrolyte flow loop between the negative electrode and the negative electrolyte tank to determine a state of charge of the negative electrolyte, or both, wherein the color sensor comprises a red/green/blue (RGB) sensor or a light source and a photodiode.

20. The redox flow battery system of claim 13 further comprising:
a diffusion cell comprising a positive electrode, a negative electrode, and a separator positioned between the positive electrode and the negative electrode, the diffusion cell being in fluid communication with an outlet of the positive electrolyte tank and an inlet to a positive electrode side of the rechargeable cell, and the diffusion cell being in selective communication an outlet of the negative electrolyte tank and an inlet of a negative side of the rechargeable cell.
